(19) United States
(12) Patent Application Publication
(10) Pub. No.: US 2015/0005702 A1
(43) Pub. Date: Jan. 1, 2015

(54) Pill Administration Device with Liquid Reservoir

(71) Applicant: Ino-Products Inc., Toronto (CA)

(72) Inventor: Douglas Bruce Soper, Toronto (CA)

(73) Assignee: Ino-Products Inc., Toronto (CA)

(21) Appl. No.: 13/932,223

(22) Filed: Jul. 1, 2013

(51) Int. Cl. A61J 1/20; A61J 1/14; A61J 7/00

(52) U.S. Cl. CPC A61J 1/2093; A61J 7/0046; A61J 1/1412; A61J 2001/1418
USPC 604/78

(57) ABSTRACT

A pill administration device has a collapsible reservoir that can contain liquid and a pill receptacle that is coupled to the reservoir and can store one or more pills, with two rupturable membranes keeping the pill(s) isolated from the liquid and trapped in the pill receptacle. By collapsing the reservoir containing the liquid, a user can break the membranes and propel the liquid and pill(s) into his or her mouth to be swallowed.

### TECHNICAL FIELD

The present disclosure relates to pill administration devices, and more particularly to pill administration devices for using liquids to administer pills.

### BACKGROUND

Medication, vitamins, nutritional supplements and other materials are often administered in pill form. The term “pill”, as used herein, includes not only agglomerations of particulate matter (whether coated or uncoated), but also liquid-filled and powder-filled capsules having at least a solid exterior and administered by swallowing, including prescribed medication, over-the-counter medication, and vitamins and other nutritional supplements.

Many people find it easier to swallow pills when swallowing liquid at the same time. To this end, a number of devices have been developed to support the liquid-facilitated ingestion of pills, including those described in U.S. Pat. No. 7,055,709 to Esau, U.S. Pat. No. 6,386,358 to North et al., U.S. Pat. No. 6,047,817 to Taylor et al. and U.S. Patent Application Publication No. 2011/0224604. However, each of these devices has certain disadvantages.

### SUMMARY

A pill administration device has a collapsible reservoir that can contain liquid and a pill receptacle that is coupled to the reservoir and can store one or more pills. Two spaced-apart rupturable membranes keep the pill(s) isolated from the liquid and trapped in the pill receptacle. By collapsing the reservoir, a user can break the membranes and propel the liquid and pill(s) into his or her mouth to be swallowed.

In one aspect, a pill administration device comprises a collapsible reservoir for containing a liquid, with the reservoir being formed by a container, a pill receptacle for containing one or more pills, and a first cap. The pill receptacle is coupled to the reservoir in sealed fluid communication therewith, is isolated from the reservoir by a first rupturable fluid impermeable membrane, and has a receptacle opening remote from the reservoir and from the first membrane for inserting and discharging pills. The first cap has a pill expulsion passage defined therethrough, and a second rupturable membrane extends across the pill expulsion passage to close the pill expulsion passage. The first cap is securable over the pill receptacle to trap one or more pills in the pill receptacle between the first and second membranes. In operation, collapsing the reservoir drives liquid contained therein to rupture the first and second membranes and travel through the pill expulsion passage to exit the pill administration device.

In one embodiment, the pill receptacle is formed by the container. In this embodiment, a quantity of liquid may be disposed in the reservoir, and the first membrane may be sealingly secured directly to the container. In this embodiment, preferably the container has an open end, the pill receptacle is disposed between the first membrane and the open end of the container, and the first cap is securable to the open end of the container. The container may be a bottle having a body and a neck extending from the body, with the neck forming the open end of the container, the reservoir being formed by the body of the bottle and the pill receptacle being formed in the neck of the bottle. In this particular embodiment, the neck of the bottle may be externally threaded and the first cap may be at least partially internally threaded so that the first cap is threadedly receivable on the neck of the bottle.

In other embodiments, the pill administration device further comprises a second cap. In these embodiments, the container has an open end, the pill receptacle is formed in the second cap, the first membrane is sealingly secured to the second cap and the second cap is securable to the container.

In one particular embodiment, the first cap is securable to the container. Preferably, in this embodiment the open end of the container is both internally and externally threaded, the first cap is at least partially internally threaded so that the first cap is threadedly receivable on the open end of the container, and the second cap is at least partially externally threaded so that the second cap is threadedly receivable inside the open end of the container.

In another particular embodiment, the first cap is securable to the second cap. In this embodiment, preferably the open end of the container is externally threaded, the second cap is at least partially internally threaded so that the second cap is threadedly receivable on the open end of the container, and the second cap is at least partially externally threaded and the first cap is at least partially internally threaded so that the first cap is threadedly receivable on the second cap.

The reservoir may be formed from a resilient material.

### BRIEF DESCRIPTION OF THE DRAWINGS

These and other features will become more apparent from the following description in which reference is made to the appended drawings wherein:

FIG. 1 is a side cross-sectional view of a first exemplary pill administration device, shown in a disassembled condition in combination with pills;

FIG. 2 is a side cross-sectional view of the pill administration device of FIG. 1, shown in an assembled condition with pills contained in a pill receptacle thereof;

FIG. 3 is a perspective view of the pill administration device of FIG. 1;

FIG. 4 is a side cross-sectional view of the pill administration device of FIG. 1, showing the device in use;

FIG. 5 is a side cross-sectional view of a second exemplary pill administration device, shown in a disassembled condition in combination with pills;

FIG. 6 is a side cross-sectional view of the pill administration device of FIG. 5, shown in an assembled condition with pills contained in a pill receptacle thereof;

FIG. 6A is a detail view showing a portion of the assembled pill administration device shown in FIG. 6;

FIG. 7 is a perspective view of the pill administration device of FIG. 5;

FIG. 8 is a side cross-sectional view of a third exemplary pill administration device, shown in a disassembled condition in combination with pills;

FIG. 9 is a side cross-sectional view of the pill administration device of FIG. 8, shown in an assembled condition with pills contained in a pill receptacle thereof; and

FIG. 10 is a perspective view of the pill administration device of FIG. 8.

### DETAILED DESCRIPTION

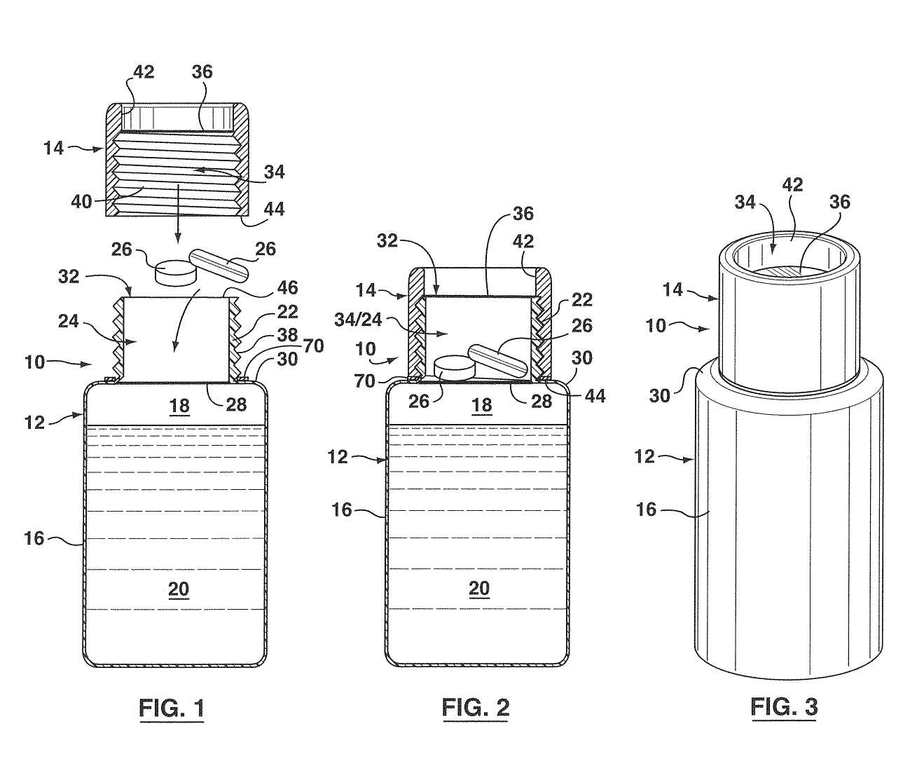

Reference is now made to FIGS. 1, 2 and 3, in which a first exemplary embodiment of a pill administration device is indicated generally at 10. The pill administration device 10 comprises a container 12 and a cap 14. As explained in greater detail below, the container 12 has an open end to which the cap 14 is securable.

As best seen in FIGS. 1 and 2, in the illustrated embodiment, the container 12 is a bottle having a body 16 which forms a reservoir 18 within which is contained a liquid 20, and a neck 22 whose interior space forms a pill receptacle 24 for containing one or more pills 26. Thus, in the exemplary embodiment shown in FIGS. 1 to 4, the pill receptacle 24 is formed by the container 12. The neck 22, and hence the pill receptacle 24, is coupled to the reservoir 18 in sealed fluid communication therewith and is isolated from the reservoir 18 by a first rupturable fluid-impermeable membrane 28 sealingly secured directly to the container 12 and extending across the neck 22 at the junction between the neck 22 and the shoulder 30 of the container 12.

In the exemplary embodiment shown in FIGS. 1 to 4, the neck 22 is open at the end thereof that is distal from the shoulder 30 of the container 12, forming a receptacle opening 32 into the pill receptacle 24. Thus, the neck 22 forms the open end of the container 12. The receptacle opening 32 is remote from the reservoir 18 and from the first membrane 28. Thus, the pill receptacle 24 is disposed between the first membrane 28 and the open end of the container 12, that is, the receptacle opening 32. The receptacle opening 32 allows for inserting pills, as shown in FIG. 1, and for discharging of pills, as described further below. The pill administration device 10 shown in FIGS. 1 to 4 would typically be distributed and sold with the liquid 20 already contained in the reservoir 18 and sealed therein by the first membrane 28. The liquid may be water or a flavoured liquid, and in some embodiments, the liquid may be, or may contain, medication or nutritional supplements.

The cap 14 is open at both ends and has a pill expulsion passage 34 defined therethrough. A second rupturable membrane 36 is secured to the cap 14 and extends across the pill expulsion passage 34 to close the pill expulsion passage 34 and prevent pills from travelling through the pill expulsion passage 34 when the cap 14 is secured to the neck 22 and the second membrane 36 is intact. Although the second membrane 36 may include one or more small apertures as long as they are not large enough to allow the pills 26 to escape, the second membrane 34 is preferably fluid-impermeable and sealingly secured to the cap 14 to seal the pill expulsion passage 34. The cap 14 is securable over the pill receptacle 24 by securing the cap 14 to the container 12 with the pill expulsion passage 34 in registration with the receptacle opening 32 to trap one or more pills 26 in the pill receptacle 24 between the first and second membranes 28, 36, as shown in FIG. 2. While the cap 14 is preferably releasably securable to the container 12 in the sense that it can be easily removed if desired, in certain embodiments a locking mechanism may be provided to inhibit removal of the cap from the container once secured.

In the illustrated embodiment shown in FIGS. 1 to 4, the neck 22 of the container has external threads 38 so as to be externally threaded and the pill expulsion passage 34 defined through the cap 14 has internal threads 40 such that the cap 14 is internally threaded, with the cap 14 thereby being threadedly receivable on the neck 22 of the container 12. Equivalently, the neck may be internally threaded and the cap may be externally threaded so that the cap is threadedly received within the neck. When the cap 14 is threaded onto the neck 22, the pill receptacle 24 and the pill expulsion passage 34 occupy substantially the same space. A resilient annular washer 70 is secured to the shoulder 30 so as to surround the base of the neck 22; the washer 70 cooperates with the proximal end 44 of the cap 14 to assist in providing a fluid-tight seal when the cap 14 is threaded onto the neck 22. As can be seen in FIG. 2, the cap 14 includes a smooth, unthreaded internal surface 42 which limits longitudinal travel of the cap 14 along the neck 22, and the length of the neck 22 is such that when the cap 14 is threaded onto the neck 22, the proximal end 44 of the cap 14 engages the washer 70 on the shoulder 30 of the container 12 before the distal end 46 (FIG. 1) of the neck 22 contacts the second membrane 36 to prevent damage thereto. Alternatively, the second membrane may be supported by an inwardly projecting annular shoulder, which either supports the second membrane against the distal end of the neck, or spaces the second membrane from the distal end of the neck when the cap is fully tightened onto the neck.

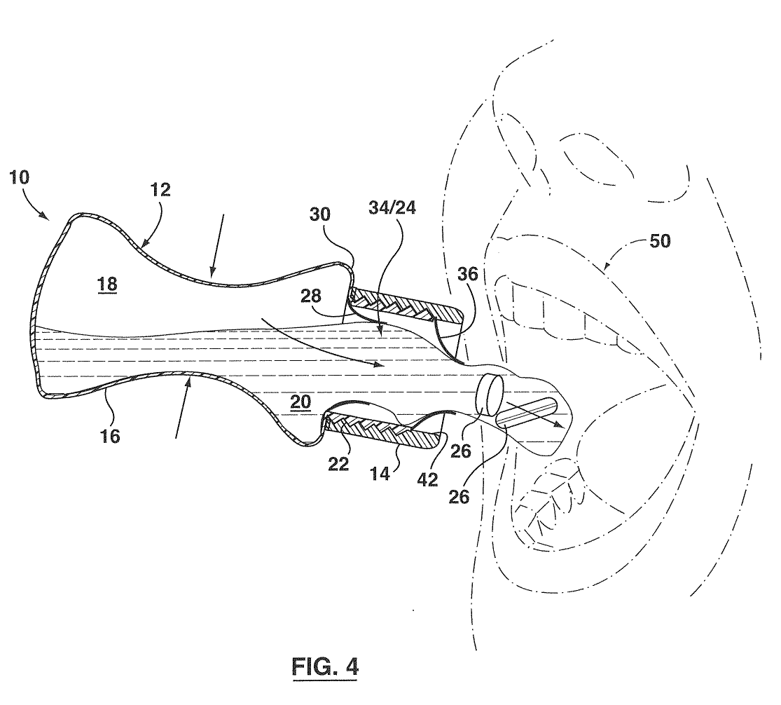

The reservoir 18 is collapsible, and in the illustrated embodiment the body 16 of the container 12 is formed from a resilient material, such as a suitably pliable plastic, to achieve this end. Thus, in the illustrated embodiment, by squeezing the body 16 of the container 12 with his or her hand, a user can collapse the reservoir 18, as described further below with reference to FIG. 4. Other embodiments may employ mechanical constructs for collapsing the reservoir, for example a plunger arrangement.

Continuing to refer to FIGS. 1 and 2, a user may prepare the pill administration device 10 for use by (if necessary) removing the cap 14 from the container 12 and placing one or more selected pills 26 into the pill receptacle 24 through the receptacle opening 32 and then securing the cap to the container so that the pills 26 are trapped in the pill receptacle 24 by the membranes 28, 36 as explained above. A user can select which pills to use with the pill administration device 10. For example, a user who has a heart condition may place pills containing a medically prescribed dosage of acetylsalicylic acid (also known under the name Aspirin) into the pill receptacle 24 so that the dosage can be quickly consumed in the event of chest pain. A user may place any desired pills in the pill receptacle 24.

FIG. 4 shows the pill administration device 10 in use. To use the pill administration device 10 when the pills 26 are trapped in the pill receptacle 24, a user would raise the pill administration device 10 to position the pill expulsion passage 34 in the cap 14 in registration with the user's mouth, and then apply pressure to the body 16 of the container 12 to collapse the reservoir 18. Collapsing the reservoir 18 drives the liquid 20 contained therein under pressure toward the first membrane 28, which ruptures under the pressure from the liquid 20. The liquid 20 continues under pressure into the pill receptacle 24 and the pill expulsion passage 34 (which as noted above occupy substantially the same space) and entrains the pills 26. The liquid 20, still under pressure, continues to travel through the pill expulsion passage 34 and engages and ruptures the second membrane 36, after which the liquid 20, carrying the pills 26, exits the pill administration device 10 toward a user's mouth 50. Thus, by raising the pill administration device 10 to his or her mouth and then squeezing the body 16 of the container 12, the user can rupture the membranes 28, 36 and propel the liquid 20 and entrained pills 26 into his or her mouth to be swallowed.

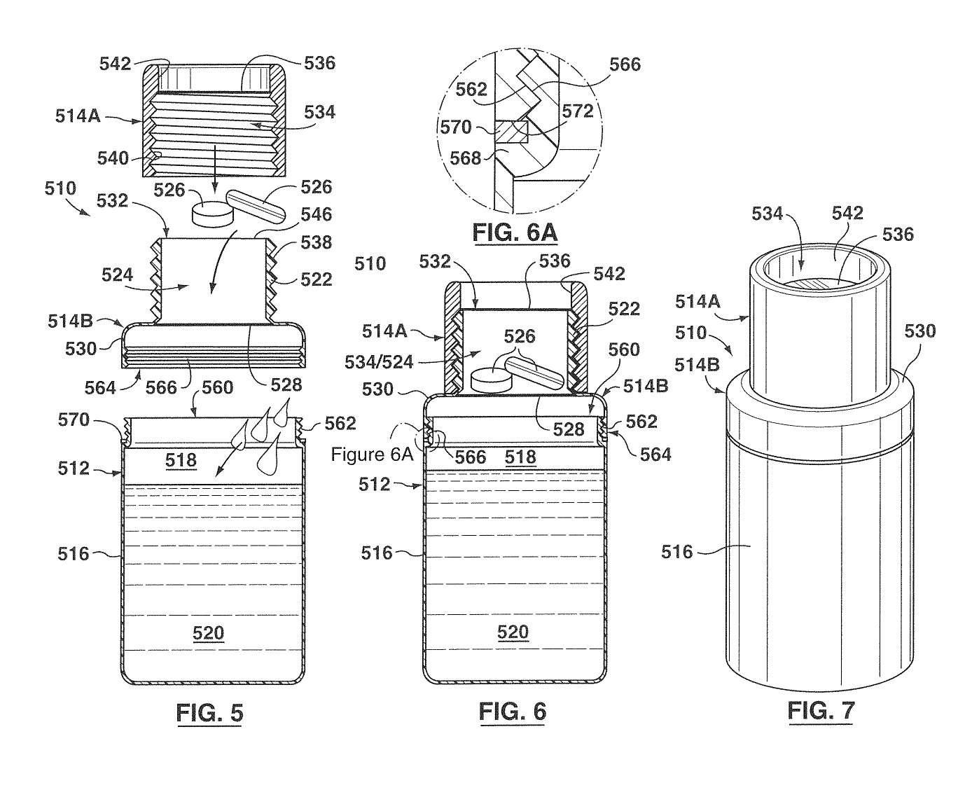

Reference is now made to FIGS. 5, 6 and 7, in which a second exemplary embodiment of a pill administration device is indicated generally at 510. The pill administration device 510 comprises a container 512, a first cap 514A and a second cap 514B, with the second cap 514B being securable to an open end 560 of the container 512. The container 512 has a body 516 of resilient material which forms a collapsible reservoir 518 within which may be contained a liquid 520. As noted above, in alternate embodiments mechanical constructs may be used to form a collapsible reservoir.

As best seen in FIGS. 5 and 6, in the second exemplary embodiment a pill receptacle 524 is formed in the second cap 514B. More particularly, the second cap 514B comprises a shoulder 530 coupled to a neck 522 whose interior space forms a pill receptacle 524 for containing one or more pills 526. The neck 522 is open at the end 546 thereof (FIG. 5) that is distal from the shoulder 530, forming a receptacle opening 532 into the pill receptacle 524. A first rupturable fluid-impermeable membrane 528 is sealingly secured to the second cap 514B and extends across the neck 522 at the junction between the neck 522 and the shoulder 530.

In the exemplary embodiment shown in FIGS. 5 to 7, the open end 560 of the container 512 has external threads 562, and the end 564 of the second cap 514B adjacent the shoulder 530 thereof has corresponding internal threads 566, so that the second cap 514B is threadedly receivable on the open end 560 of the container 512. Equivalently, the open end of the container may have internal threads and the second cap may have external threads. In a preferred embodiment, as best seen in FIG. 6A, an annular shoulder 568 is provided at the base of the external threads 562 on the container 512, on which is seated a resilient washer 570 for engaging the rim 572 at the end 564 of the second cap 514B adjacent the shoulder 530 to assist in providing a fluid-tight seal between the container 512 and the second cap 514B.

The first cap 514A of the embodiment shown in FIGS. 5 to 7 is substantially identical to the cap 14 shown in FIGS. 1 to 4, and is open at both ends with a pill expulsion passage 534 defined therethrough and a second rupturable membrane 536 secured thereto and extending across the pill expulsion passage 534 to close it. The first cap 514A also includes a smooth, unthreaded internal surface 542 which limits longitudinal travel of the first cap 514A. The first cap 514A is securable over the pill receptacle 524 by securing the first cap 514A to the second cap 514B with the pill expulsion passage 534 in registration with the receptacle opening 532, thereby trapping one or more pills 526 in the pill receptacle 524 between the first and second membranes 528, 536, as shown in FIG. 6. The first cap 514A is preferably releasably securable to the second cap 514B, although a locking mechanism may be provided. In the particular exemplary embodiment shown in FIGS. 5 to 7, the neck 522 of the second cap has external threads 538 so as to be externally threaded and the pill expulsion passage 534 defined through the first cap 514A has internal threads 540 such that the first cap 514A is internally threaded, with the first cap 514A thereby being threadedly receivable on the neck 522 of the second cap 514B. In other embodiments, the first cap may have external threads and the neck may have internal threads. As in the first embodiment shown in FIGS. 1 to 4, when the first cap 514A is threaded onto the neck 522, the pill receptacle 524 and the pill expulsion passage 534 occupy substantially the same space.

A user may fill the reservoir 518 formed by the container 512 with any desired liquid 520, and then secure the second cap 514B to the open end 560 of the container 512. In this configuration, the pill receptacle 524 in the neck 522 of the second cap 514B is coupled to the reservoir 518 in sealed fluid communication therewith, and the first membrane 528 will isolate the pill receptacle 524 from the reservoir 518. The user may then prepare the pill administration device 510 for use by placing one or more selected pills 526 into the pill receptacle 524 through the receptacle opening 532 and then securing the first cap 514A to the second cap 514B so that the pills 526 are trapped in the pill receptacle 524 by the membranes 528, 536. Use of the pill administration device 510 shown in FIGS. 5 to 7 is similar to that shown and described above in respect of the pill administration device 10 shown in FIGS. 1 to 4: by squeezing the body 516 of the container 512, the user can rupture the membranes 528, 536 and propel the liquid 520 and entrained pills 526 into his or her mouth to be swallowed. Moreover, if the pill administration device 510 is not used and the pills 526 and/or liquid 520 become too old, by removing the first and second caps 514A, 514B, the pills 524 and liquid 520 may be discarded and replaced with fresh substitutes.

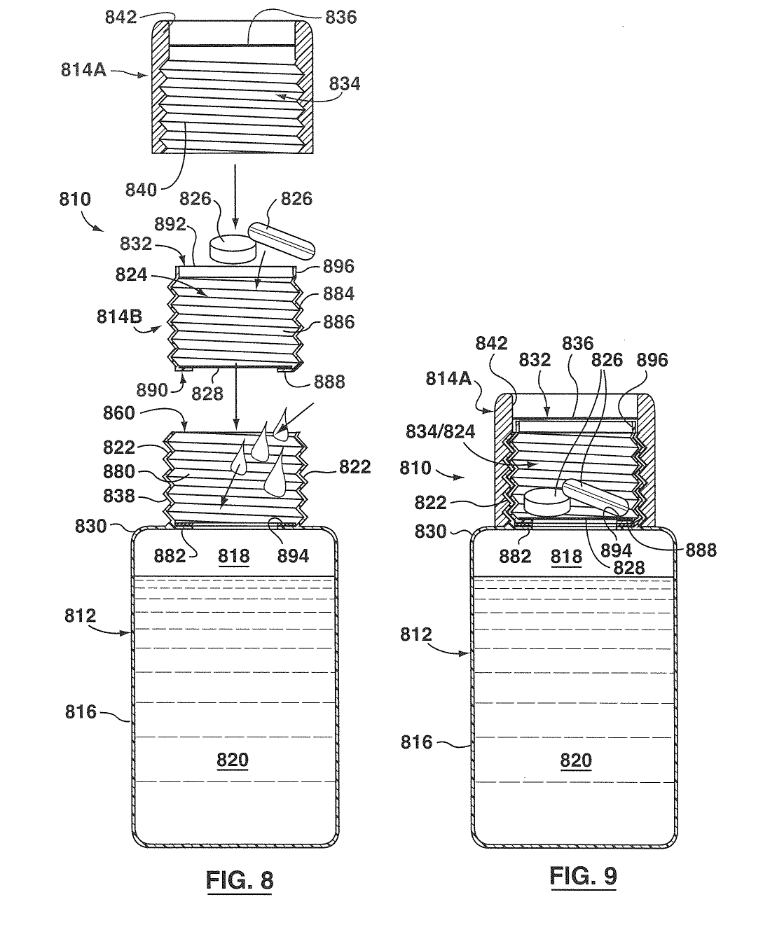

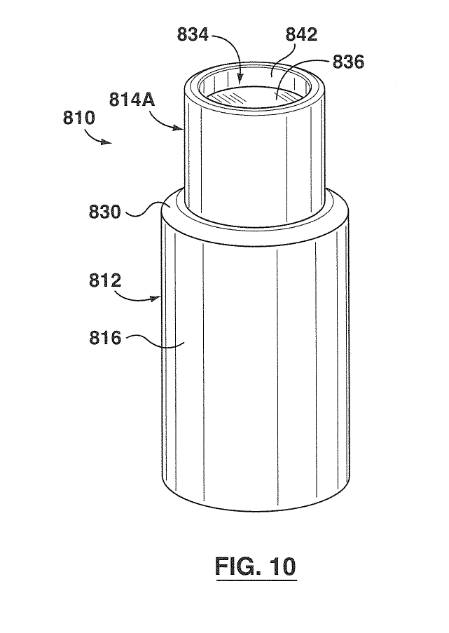

Reference is now made to FIGS. 8 to 10, which show a third exemplary embodiment of a pill administration device, indicated generally by reference numeral 810. The pill administration device 810 comprises a container 812, a first cap 814A and a second cap 814B, with the second cap 814B being securable to an open end 860 of the container 812. The container 812 of the third embodiment is similar to the container 12 of the first embodiment, with like reference numerals referring to like features except with the prefix “8”. The container 812 of the third embodiment differs from the container 12 of the first embodiment in that the neck 822 of the container 812 has both external threads 838 and internal threads 880, and instead of a rupturable fluid-impermeable membrane, includes an inwardly projecting annular flange 882 at the junction between the neck 822 and the shoulder 830.

The second cap 814B takes the form of a tube whose interior space forms a pill receptacle 824 for containing one or more pills 826. The second cap 814B has both external threads 884 and internal threads 886, and has an inwardly projecting annular flange 888 at one end 890 thereof across which is sealingly secured a first rupturable fluid-impermeable membrane 828. The end 892 of the second cap 814B opposite the annular flange 888 is open, forming a receptacle opening 832 into the pill receptacle 824.

The second cap 814B is securable to the container 812, in the illustrated embodiment the external threads 884 on the second cap 814B are interengageable with the internal threads 880 on the neck 822 of the container 812 so that the second cap 814B is threadedly receivable inside the neck 822 that defines the open end 860 of the container 812. In the illustrated embodiment, the annular flange 882 at the junction between the neck 822 and the shoulder 830 of the container carries a resilient washer 894 and the annular flange 888 on the second cap 814B seats against the washer 894, as shown in FIG. 9, to assist in providing a fluid-tight seal. In a preferred embodiment, the second cap 814B includes a projection 896 at the open end 892 thereof which, when the second cap 814B is fully threaded into the neck 822, projects slightly beyond the neck 822. This projection 896 provides a gripping surface to assist a user in threading the second cap 814B into the neck 822 of the container 812.

The first cap 814A of the embodiment shown in FIGS. 8 and 9 is substantially identical to the cap 14 shown in FIGS. 1 to 4, and is open at both ends with a pill expulsion passage 834 defined therethrough and a second rupturable membrane 836 secured thereto and extending across the pill expulsion passage 834 to close the pill expulsion passage 834. Like the cap 14 shown in FIGS. 1 to 4, the first cap 814A of the embodiment shown in FIGS. 8 has internal threads 840 that interengage with the external threads 838 on the neck 822 so that the first cap 814A is threadedly receivable on the neck 822 of the container 812 so as to be secured over the pill receptacle 824, and includes a smooth, unthreaded internal surface 842 which limits longitudinal travel of the first cap 514A. The first cap 814 is preferably releasably securable to the container 812 although a locking mechanism may be provided. In the embodiment shown in FIGS. 8 to 10, the internal threads 886 on the second cap 814B may be omitted; in alternate embodiments in which the first cap is externally threaded the internal threads 886 could interengage with those external threads so that the first cap could be threadedly received inside the second cap 814B.

A user may use any desired liquid to fill the reservoir 818 formed by the container 812, and then secure the second cap 814B inside the neck 822 of the container 812. This will couple the pill receptacle 824 formed by the interior of the second cap 814B in sealed fluid communication with the reservoir 818, with the first membrane 828 isolating the pill receptacle 824 from the reservoir 818. The user can then place one or more selected pills 826 into the pill receptacle 824 through the receptacle opening 832 and then secure the first cap 814A to the neck 822 of the container 812 so that the pills 826 are trapped in the pill receptacle 824 by the membranes 828, 836. Use of the pill administration device 810 shown in FIGS. 8 and 9 is analogous to that shown and described above in respect of the above-described pill administration devices 10 in that a user would squeeze the body 816 of the container 812 to rupture the membranes 828, 836 and propel the liquid 820 and entrained pills 826 through the pill expulsion passage 834. Analogously to the second embodiment shown in FIGS. 5 to 7, a user can remove the first and second caps 814A, 814B to discard and replace the pills 524 and liquid 520.

The term “rupturable”, as used in reference to the membranes 28, 36, 528, 536, 828, 836 means that the membranes 28, 36, 528, 536, 828, 836, although strong enough, at atmospheric pressure and subject to mild impacts and other disturbances, to respectively retain the liquid 20, 520, 820 in the reservoir 18, 518, 818 and maintain the pills 26, 526,826 trapped in the pill receptacle 24, 524, 824, are weak enough to rupture easily under pressure from the liquid 20, 520, 820 being forced against them by collapsing of the reservoir 18, 518, 818. Thus, the membranes 28, 36, 528, 536, 828, 836 are different from the more robust product seals that are circumferentially adhered to the lip of a bottle and designed to resist rupture and be peeled away from the bottle lip when the product contained therein is to be used. The membranes 28, 36, 528, 536, 828, 836 may be formed from a suitable thin single-layer or multilayer plastic film, and may include a thin aluminum foil layer.

Resilient washers 70, 570 and 894 have been shown and described herein. One skilled in the art, now informed by the herein disclosure, will appreciate that resilient washers and other sealing members may be included at other appropriate locations as well.

Several currently preferred embodiments have been described by way of example. It will be apparent to persons skilled in the art that a number of variations and modifications can be made without departing from the scope of the claims.

What is claimed is:

1. A pill administration device, comprising:
a collapsible reservoir for containing a liquid, the reservoir being formed by a container; and
a pill receptacle for containing one or more pills;
wherein:
the pill receptacle is coupled to the reservoir in sealed fluid communication therewith;
the pill receptacle is isolated from the reservoir by a first rupturable fluid impermeable membrane; and
the pill receptacle has a receptacle opening remote from the reservoir and from the first membrane for inserting and discharging pills; and
a first cap having a pill expulsion passage defined therethrough;
a second rupturable membrane extending across the pill expulsion passage to close the pill expulsion passage;
the first cap being securable over the pill receptacle to trap one or more pills in the pill receptacle between the first and second membranes;
wherein, in operation, collapsing the reservoir drives liquid contained therein to rupture the first and second membranes and travel through the pill expulsion passage to exit the pill administration device.

2. The pill administration device of claim 1, wherein the pill receptacle is formed by the container.

3. The pill administration device of claim 2, wherein:
a quantity of liquid is disposed in the reservoir; and
the first membrane is sealingly secured directly to the container.

4. The pill administration device of claim 3, wherein:
the container has an open end;
the pill receptacle is disposed between the first membrane and the open end of the container; and
the first cap is securable to the open end of the container.

5. The pill administration device of claim 4, wherein the container is a bottle having a body and a neck extending from the body, the neck forming the open end of the container, and wherein:
the reservoir is formed by the body of the bottle; and
the pill receptacle is formed in the neck of the bottle.

6. The pill administration device of claim 5, wherein:
the neck of the bottle is externally threaded; and
the first cap is at least partially internally threaded so that the first cap is threadedly receivable on the neck of the bottle.

7. The pill administration device of claim 1, further comprising a second cap, wherein:
the container has an open end;
the pill receptacle is formed in the second cap;
the first membrane is sealingly secured to the second cap; and
the second cap is securable to the container.

8. The pill administration device of claim 7, wherein the first cap is securable to the container.

9. The pill administration device of claim 8, wherein
the open end of the container is both internally and externally threaded;
the first cap is at least partially internally threaded so that the first cap is threadedly receivable on the open end of the container; and
the second cap is at least partially externally threaded so that the second cap is threadedly receivable inside the open end of the container.

10. The pill administration device of claim 7, wherein the first cap is securable to the second cap.

11. The pill administration device of claim 10, wherein:
the open end of the container is externally threaded;
the second cap is at least partially internally threaded so that the second cap is threadedly receivable on the open end of the container; and
the second cap is at least partially externally threaded and the first cap is at least partially internally threaded so that the first cap is threadedly receivable on the second cap.

12. The pill administration device of claim 1, wherein the reservoir is formed from a resilient material.
